(19) United States
(12) Patent Application Publication
(10) Pub. No.: US 2019/0283490 A1
(43) Pub. Date: Sep. 19, 2019

(54) DECORATED SURFACE-STRUCTURED WALL OR FLOOR PANEL BASED ON A FIBER CEMENT SHEET

(71) Applicant: Akzenta Paneele + Profile GMBH, Kaisersesch (DE)

(72) Inventor: Hans-Jürgen HANNIG, Bergisch Gladbach (DE)

(21) Appl. No.: 16/463,072

(22) PCT Filed: Dec. 21, 2017
(86) PCT No.: PCT/EP2017/084068

§ 371 Date: May 22, 2019

(30) Foreign Application Priority Data
Jan. 13, 2017 (EP) 17151456.5

(51) Int. Cl. B44C 5/04; B44C 1/24; B32B 3/06; B32B 3/26; B32B 13/02; B32B 13/12; B32B 27/36; B32B 37/18; B32B 38/06; B32B 38/00; E04F 13/14; E04F 15/08

(52) U.S. Cl. CPC B44C 5/04; B32B 2607/00; B32B 3/06; B32B 3/263; B32B 13/02; B32B 13/12; B32B 27/36; B32B 37/182; B32B 38/06; B32B 38/0008; E04F 13/14; E04F 15/08; B44C 5/0461; B32B 2038/0076; B32B 2250/02; B32B 2255/10; B32B 2255/28; B32B 2305/30; B32B 2305/72; B32B 2305/77; B32B 2310/0806; B32B 2315/06; B32B 2367/00; B32B 2419/04; B32B 2451/00; B44C 1/24

(57) ABSTRACT

The disclosure relates to a decorated, surface-structured wall or floor panel and a method for manufacturing same. The decorated, surface-structured wall or floor panel of the disclosure comprises a substrate made of a fiber cement material, a primer coat on a surface of the substrate, a decorative coat on the primer coat, a coat of radiation curable varnish or hot melt on the decorative coat, a structured plastic film on the coat of radiation-curable varnish or hot melt, and a coat of finishing varnish on the structured plastic film.

### CROSS-REFERENCE TO RELATED APPLICATIONS

This application is a National Stage of International Application No. PCT/EP2017/084068 filed on Dec. 21, 2017. This application claims the priority to European Patent Application No. 17151456.5, filed on Jan. 13, 2017. The entire disclosures of the above applications are incorporated herein by reference.

### FIELD

The present disclosure relates to a decorated and preferably surface-structured wall or floor panel based on a fiber cement sheet. The present disclosure further relates to a method for producing a decorated and surface-structured wall or floor panel based on a fiber cement sheet.

### BACKGROUND

This section provides background information related to the present disclosure which is not necessarily prior art.

Such decorated panels are known per se, wherein the term wall panel also means panels which are suitable as a ceiling or door lining. They usually consist of a carrier or core of a solid material, such as a wood material, which is provided on at least one side with a decorative layer and a covering layer and optionally with further layers, such as a wearing layer disposed between the decorative and the covering layer. The decorative layer is usually a printed paper impregnated with a resin or a printing layer applied onto the carrier by use of, for example, a suitable printing sub-surface.

A method for producing a decorated wall or floor panel is known from document EP 2 829 415 A1, in which, starting from a granular carrier material, a carrier and subsequently a panel are formed. In such a method, for example, a WPC can be used as a carrier material.

Panels based on wood materials have a higher fire load than mineral wall or floor coverings such as tiles, so that their field of application is partially limited. In contrast, the known mineral wall or floor coverings are limited in terms of their variety of decoration.

The production of the panels as well as the panels themselves still offer potential for improvement in this respect. Potential for improvement may in particular be provided with regard to the applicability at the site of the end user.

In order to improve the realistic impression of the panels, it is known from the prior art to provide them with a surface structure in order to achieve a haptic effect adapted to a natural material. Here, it may be provided, for example, that in a wood decor the structure of the grain is formed by a surface structure matching with the visual representation of the wood grain.

### SUMMARY

This section provides a general summary of the disclosure, and is not a comprehensive disclosure of its full scope or all of its features.

It is therefore the object of the present disclosure to provide a surface-structured decorated wall or floor panel which enables an improved applicability while providing good properties in particular with regard to its fire properties. Moreover, it is the object of the present disclosure to provide a method for producing a surface-structured decorated wall or floor panel based on a fiber cement sheet.

This object is achieved by a decorated and surface-structured panel comprising the features of claim 1. This object is further achieved by a method comprising the features of claim 11. Preferred embodiments of the disclosure are set forth in the dependent claims, in the description or in the figures, wherein further features described or shown in the dependent claims or in the description or in the figures may individually or in any combination constitute an object of the disclosure, if the opposite is not clearly obvious from the context.

In the sense of the present disclosure, a fiber cement sheet is a sheet obtained from a suitable cement with the addition of a fiber material and optionally a filler and/or a solid material.

The disclosure provides a decorated wall or floor panel comprising
a carrier plate made of a fiber cement material,
a primer layer disposed on a surface of the carrier plate,
a decorative layer disposed on the primer layer,
a layer of a radiation-curable varnish or hot melt disposed on the decorative layer,
a structured plastic film disposed on the layer of a radiation-curable varnish or hot melt, and
a topcoat layer disposed on the structured plastic film.

The term “decorated wall or floor panel” or “decorative panel” in the sense of the disclosure means in particular wall, ceiling, door or floor panels comprising a decoration which replicates a decorative template and is applied onto a carrier plate. Decorative panels are used in a variety of ways, both in the field of interior design of rooms, as well as a decorative cladding of buildings, for example in exhibition stand construction. The decorative panels often comprise a decoration that is intended to replicate a natural material.

Examples of such replicated natural materials or decorative templates are wood species such as maple, oak, birch, cherry, ash, walnut, chestnut, wenge or even exotic woods such as Panga-Panga, mahogany, bamboo and bubinga. In addition, often natural materials such as stone surfaces or ceramic surfaces are replicated.

Accordingly, a “decorative template” in the sense of the present disclosure in particular means such an original natural material or at least a surface of such a material, which is to be imitated or replicated by the decoration.

A “carrier” or a “carrier plate” may in particular be understood as a layer serving as a core or as a base layer in a finished panel. For example, the carrier may already impart a suitable stability to the panel or contribute thereto.

Accordingly, a carrier material can be understood as a material which forms the carrier at least to a predominant part. In particular, the carrier can consist of the carrier material.

According to the disclosure, a fiber cement is intended as the carrier material, from which plate-shaped carriers are produced by means of suitable methods, such as, for example, the Hatschek method.

According to an embodiment of the disclosure, the fiber cement usable according to the disclosure can comprise binders, additives or fillers and fibers as solid constituents. In addition, such fiber cements may include water as well as air or air inclusions.

The fiber cements which can be used in one embodiment of the disclosure can comprise fibers of an organic nature, such as, for example, plant fibers, animal fibers, such as animal hair, cellulose fibers, wood fibers, as well as of an inorganic nature, such as, for example, of mineral nature.

The fiber material may include inorganic fibers such as glass fibers, mineral fibers, metal fibers such as steel fibers or ceramic fibers, or synthetic fibers based on suitable plastics. Of course, the fiber material may also comprise mixtures of such inorganic or synthetic fibers.

Examples of plant fibers are cellulose fibers, lignose fibers and fibers of straw, maize straw, bamboo, leaves, algae extracts, hemp, cotton or oil palm fibers. Examples of animal fiber materials are keratin-based materials such as wool or horse-hair.

Suitable synthetic fibers include, for example, polyvinyl alcohol fibers, polylactide fibers, polyamide fibers, polyimide fibers, polyamide imide fibers, polyphylensulfide fibers, polyacrylonitrile fibers, polyester fibers, polyethylene terephthalate fibers, polyethylene fibers, polypropylene fibers, polyurethane fibers, polyvinyl chloride fibers, polytetrafluoroethylene fibers, aromatic polyamide fibers (aramid) or carbon fibers.

Suitable cements as binders in fiber cement sheets which can be used according to the disclosure as carrier plates are, for example, Portland cement, blast furnace cement, trass cement, clay cement. In addition, the fiber cement may comprise further hydraulically setting binders such as gypsum, bassanite, Pozzolan or hydraulic limestones.

As additives, the fiber cement may comprise, for example, mineral solids such as rock flour, or organic solids such as wood flour. These may preferably have a particle size of less than 800 μm, preferably of less than 600 μm. As a result, the solid can be distributed very finely in the fiber cement. The solid may, for example, be a wood material, such as wood flour, or another material, for example a component of the rice plant, such as the rice spelt, the rice stem and the rice husk, cellulose or a mineral material, such as stone flour, chalk or other inorganic mineral materials.

It may be particularly preferred if the solid material is formed from talcum, for example consists thereof. Talcum is understood in a manner known per se as a magnesium silicate hydrate, which may have, for example, the chemical formula Mg₃[Si₄O₁₀(OH)₂].

Further suitable additives are, for example, fly ash or basalt flour.

Furthermore, the fiber cement may include as an additive for example pigments such as titanium dioxide, ultramarine, turquoise, cinnabar, iron pigments such as iron oxide or iron cyan blue, carbon black, bismuth pigments such as bismuth vanadate, cadmium pigments, chromate pigments, spinel pigments, hematite pigments or the like. Likewise, organic pigments may be included as an additive.

It may be advantageous if the specific surface density according to ISO 4352 (BET) of the additives is in a range from ≥4 m²/g to 8 m²/g, such as in a range from ≥5 m²/g to ≤7 m²/g. Furthermore, it may be advantageous if the additives are present at a bulk density according to DIN 53468 in a range from ≥0.15 g/cm³ to ≤0.45 g/cm³, such as in a range from ≥0.25 g/cm³ to ≤0.35 g/cm³. It can preferably be provided that the additives are present in the form of particles having a particle size D₅₀ in a range from ≥3 μm to ≤6 μm, preferably in a range of ≥4 μm to ≤5 μm, such as 4.5 μm, and/or that the additives are present in the form of particles having a particle size D₉₈ in the range of ≥10 μm to ≤30 μm, preferably in a range of ≥15 μm to ≤20 μm, such as 17 μm. In order to determine the particle size distribution, basically the generally known methods, such as laser diffractometry, can be used, by means of which particle sizes in the range of a few nanometers up to several millimeters can be determined. By means of this method it is also possible to determine D₅₀ and D₉₈ values which respectively indicate that 50% (D₅₀) or 98% (D₉₈) of the measured particles are smaller than the respective specified value.

It may be preferred that the fiber material comprises fibers having a length in a range of ≤5000 μm, preferably in a range of ≤2500 μm, such as in a range from ≥5 μm to ≤1500 μm, for example in a range of from ≥50 μm to ≤1000 μm. Surprisingly, it has been found that such fibers can provide a high stability such that significant advantages in the manufacturability can be provided. Thus, this embodiment differs markedly from the solutions of the prior art, in which, inasmuch as fibers were contained in a material, the fibers have a comparatively large fiber lengths usually in the millimeter range in order to achieve a desired effect.

Furthermore, it may be preferred that the fiber material comprises fibers having a diameter or a thickness of ≥5 μm to ≤100 μm, such as in a range from ≥7 μm to ≤50 μm.

When using metal fibers, these can also have a significantly larger diameter in a range between ≥80 μm and ≤1000 μm.

According to one embodiment of the disclosure, the ratio between the fiber length and the fiber diameter may be in a range between 20:1 and 250:1, preferably between 30:1 and 150:1.

According to one embodiment of the disclosure, the proportion of binder in the fiber cement material is in a range between ≥25 wt.-% and ≤85 wt.-%, preferably between ≥35 wt.-% and ≤75 wt.-%. The proportion of additives may be in a range between ≥2 wt.-% and ≤40 wt.-%, preferably between ≥5 wt.-% and ≤25% wt.-%. The fiber content can be in a range between ≥2 wt.-% and ≤20 wt.-%, preferably between ≥5 wt.-% and ≤15 wt.-%. Further constituents, such as water or air, may be present in a proportion which supplements the total composition to 100 wt.-%.

The edge regions of a panel according to the disclosure can be structured or profiled, in order to provide in particular detachable connecting elements. In this regard, in the case of a profiling in the sense of the disclosure it can be provided that a decorative and/or functional profile is introduced by means of suitable material-removing tools at least in a part of the edges of the decorative panel. A functional profile means, for example, the introduction of a tongue and/or groove profile in an edge to make decorative panels connectable to each other via the introduced profilings.

A decorative subsurface or primer to be provided according to the disclosure is at least applied on a part of the carrier. For example, initially a primer can be applied as a decorative subsurface in particular for printing processes. This primer may be applied, for example, in a thickness of 10 μm to 60 μm. In this case, a liquid radiation-curing mixture based on a urethane or a urethane acrylate, optionally with one or more of a photoinitiator, a reactive diluent, a UV stabilizer, a rheology agent such as a thickener, a radical scavenger, a flow control agent, a defoamer or a preservative, a pigment and/or a dye can be used as a primer.

In addition to the primer, an undercoat, in particular a colored undercoat, may be applied. For example, the undercoat may include polyurethane, for example be formed as a polyurethane varnish, and, for example, can be provided with white pigments.

The decoration or the decorative layer can be produced by a printing process, wherein flexographic printing, offset printing or screen printing processes as well as in particular digital printing techniques such as inkjet processes or laser printing processes are suitable. The decorative layer can be formed from an in particular radiation-curable paint and/or ink. For example, a UV-curable paint or ink may be used.

It is also possible, if appropriate, first to carry out a pretreatment of the carrier for electrostatic discharge and, if appropriate, a subsequent electrostatic charging prior to the printing process. This may in particular serve to avoid the occurrence of blurring in the course of the application of the decoration.

The varnish applied onto the decorative layer in order to form a layer of a radiation-curable varnish preferably comprises an acrylate, a diacrylate, a methacrylate, a urethane, urethane acrylate or mixtures thereof. In addition, such a varnish can comprise more components such as in particular a photoinitiator, a reactive diluent, a UV stabilizer, a rheology agent such as a thickener, a radical scavenger, a flow control agent, a defoamer or a preservative, a pigment and/or a dye. Of course, several and/or different of the aforementioned components may be included in such a varnish.

According to one embodiment of the disclosure, it may be provided, for example, that the varnish comprises a diacrylate in a concentration between ≥20 wt.-% and ≤60 wt.-% and a methacrylate in a concentration between ≥1 wt.-% and ≤20 wt.%.

A photoinitiator for radiation-curable varnishes or compositions which can be used in the context of the present disclosure may include, for example, compounds of the group selected from benzophenones such as 4,4-bis(diethylamino)benzophenone, and 3,3′,4,4′-tetramethoxybenzophenone, anthraquinones such as t-butylanthraquinones and 2-ethylanthraquinones, thioxanthones such as 2,4-diethylthioxanthone, isopropylthioxanthone and 2,4-dichlorothioxanthone; acetophenones such as diethoxyacetophenone, 2,2-dimethoxyphenylacetophenone, 2-hydroxy-2-methyl-1-phenylpropan-1-one, benzyldimethylketal, 1-hydroxycyclohexylphenylketone, 2-methyl-2-morpholino(4-methylthiophenyl)propan-1-one, 2-methyl-1-(4-methylthiophenyl)-2-morpholino-propan-1-one, 2-benzyl-2-dimethylam ino-1-(4-morpholinophenyl)-butanone and trichloroacetophenone; benzoin ethers such as benzoin methyl ether, benzoin ethyl ether, benzoin isopropyl ether and benzoin isobutyl ether; acylphosphine oxides such as 2,4,6-trimethylbenzoyldiphenylphosphine oxides, bis(2,6-dimethoxybenzoyl)-2,4,4-trimethylpentylphosphine oxides and bis(2,4,6-trimethylbenzoyl)-phenylphosphine oxide, methylbenzoyl formate, 1,7-bisacridinylheptane, 9-phenylacridine and azo compounds such as azobisisobutyronitrile, diazonium compounds, and tetracene compounds.

A photoinitiator can, for example, be included in the varnish composition in a concentration between 0.5 and 5 wt.-%.

A hot melt in the sense of the disclosure is preferably a solvent-free hot melt adhesive which is more or less solid at room temperature and which is applied onto the decorative layer in the hot state and forms a firm bond of the plastic film to the decorative layer in the course of a cooling process.

A hot melt suitable according to the disclosure preferably comprises a base polymer and optionally a resin component, stabilizers, waxes and/or nucleating agents. Suitable base polymers may preferably be selected from the group consisting of polyamide, polyethylene, amorphous polyalphaolefins, ethylene vinyl acetate copolymers, polyester elastomers, polyurethane elastomers, copolyamide elastomers and vinylpyrrolidone/vinyl acetate copolymers.

Suitable resin components may preferably be selected from the group consisting of colophony, terpene resins and hydrocarbon resins.

Suitable stabilizers may preferably be selected from the group consisting of antioxidants, such as phenols or peroxide decomposers, metal deactivators and light stabilizers.

As waxes, a hot melt usable according to the disclosure may preferably comprise beeswax, fruit wax or carnauba wax, as well as synthetic or partially synthetic waxes.

According to one embodiment of the disclosure, the structured plastic film may consist of a plastic which is selected from the group consisting of polypropylene (PP), polyethylene (PE), polyethylene terephthalate (PET), polycarbonate (PC), polybutylene terephthalate (PBT), a polytrimethylene terephthalate (PTT), a copolymer or a block copolymer thereof.

The plastic film preferably has a thickness between >60 μm and ≤500 μm, preferably between ≥80 μm and ≤350 μm, in particular between ≥100 μm and ≤300 μm, such as 120 μm, 140 μm, 160 μm, 180 μm, 200 μm, 220 μm, 240 μm, 260 μm or 280 μm. Such a thickness has proven to be particularly suitable with regard to the handling in the production process of the decorative panel as well as the haptic impression that can be achieved therewith.

According to a further preferred embodiment, the structured plastic film has an embossing depth between 60 μm and 180 μm. In particular, it is advantageous if the embossing depth is less than the layer thickness of the plastic film. Here, the layer thickness is to be understand as the strength of the film in unem bossed areas.

According to a further preferred embodiment of the disclosure, the embossing depth is between 25% and 65% of the layer thickness of the plastic film.

According to one embodiment of the disclosure, the varnish applied onto the structured plastic layer for forming a topcoat layer comprises an acrylate, a diacrylate, a methacrylate, a urethane, urethane acrylate or mixtures thereof. In addition, such a varnish may include further components, in particular a photoinitiator, a reactive diluent, a UV stabilizer, a rheology agent such as a thickener, a radical scavenger, a flow control agent, a defoamer or a preservative, a pigment and/or a dye. Of course, several and/or different of the aforementioned components may be included in such a varnish.

According to a further embodiment of the disclosure it may be provided that the topcoat layer is formed from a plurality of varnish layers or is formed by a multiple application of varnish compositions of the same or of different compositions. Here, it can also be provided that at least one varnish layer or a varnish coating comprises a varnish composition which includes a hard material such as titanium nitride, titanium carbide, silicon nitride, silicon carbide, boron carbide, tungsten carbide, tantalum carbide, alumina (corundum), zirconium oxide or mixtures thereof in order to increase the wear resistance of the layer formed. Likewise, it can be provided that at least one varnish layer or a varnish coating comprises a varnish composition which includes a solid, for example glass beads, glass ellipses or even cellulose fibers in order to increase the wear resistance of the layer formed. It can also be provided that a varnish layer or a varnish coating comprises a varnish composition which includes both hard materials and a solid of the aforementioned type.

Regarding the method, the object of the present disclosure is achieved by a method for producing a decorated wall or floor panel based on a fiber cement sheet, comprising the steps:
a) providing a carrier of a fiber cement material;
b) applying a primer layer onto a surface of the provided carrier;
c) applying a decorative layer onto the primer layer applied in step b) by means of a direct printing method;
d) applying a layer of a radiation-curable varnish or hot melt onto the decorative layer applied in step c); subsequently either
e1) applying a non-structured plastic film onto the not yet or not yet completely cured layer of the radiation-curable varnish or hot-melt applied in step d);
e2) curing of the layer of a radiation-curable varnish or hot melt applied in step d) by the action of suitable electromagnetic radiation or cooling, wherein the plastic film applied in step e1) is bonded to the remaining layer structure;
e3) structuring the non-structured plastic film applied in step e1) by means of an embossing means for forming a structured plastic film; or
e1′) applying a structured plastic film onto the not yet or not yet completely cured layer of the radiation-curable varnish or hot melt applied in step d);
e2′) curing the layer of the radiation-curable varnish or hot melt applied in step d) by the action of suitable electromagnetic radiation or cooling, wherein the plastic film applied in step e1′) is bonded to the remaining layer structure; subsequently
f) applying at least one covering layer of a radiation-curable varnish onto the structured plastic film; and
g) curing the at least one covering layer applied in step f).

In the sense of the present disclosure, a non-structured plastic film can be understood as a plastic film which is not completely or only partially structured and which receives an additional structuring in the course of the further process.

In the sense of the present disclosure, an incompletely or a partially cured layer of the radiation-curable varnish applied in step d) is one which has already been gelled by suitable measures, such as the action of electromagnetic radiation of low intensity and/or short duration, but is not yet fully cured and thus includes radically polymerizable components. The same applies to an incompletely cured hot melt layer, which accordingly is changed in its viscosity by cooling.

Prior to the application of the primer layer onto a surface of the provided carrier, it may be provided that the corresponding surface of the carrier is pretreated by means of a corona and/or plasma treatment. As a result, an improved adhesion of the primer layer to the surface can be achieved.

The application of the primer layer can be implemented, for example, by means of rollers, such as rubber rollers, by means of doctor blades, by means of pouring devices, by means of spraying devices or by a combination of the aforementioned devices.

For applying the decorative layer onto the primer layer applied in step b) by means of a direct printing method, in particular flexographic printing, offset printing or screen printing processes, as well as in particular digital printing techniques such as inkjet processes or laser printing processes are particularly suitable.

Subsequent to the application of the decorative layer, a layer of a radiation-curable varnish or a hot melt is applied. The application of this varnish layer can take place, for example, by means of rollers, such as rubber rollers, by means of doctor blades, by means of pouring devices, by means of spraying devices or by a combination of the aforementioned devices.

Optionally, it may be provided according to the disclosure that the applied varnish layer is partially cured by the action of electromagnetic radiation, such as UV radiation or microwave radiation, wherein this partial curing is carried out with the proviso that the applied layer still has a residual fluidity and is not fully cured.

Optionally, it may be provided according to the disclosure that the applied hot melt layer is partially cured by cooling, wherein this partial curing is carried out with the proviso that the applied layer still has a residual fluidity and is not fully cured.

Following the varnish application or hot melt application a structured or non-structured plastic film is applied onto the still flowable varnish bed or hot melt bed. This can be done for example by means of a calender in a calendering step. In this case, the plastic film can be at least partially pressed into the varnish bed. Here, preferably the application of the plastic film is implemented while avoiding the inclusion of air bubbles between the varnish layer and the plastic film.

After the application of the plastic film onto the varnish layer or the hot melt layer, the layer is cured by the action of suitable electromagnetic radiation, whereby the film applied thereon is firmly bonded to the layer structure obtained up to that point.

According to one embodiment of the method, an embossing roller, an embossing plate or an embossing die having an embossing depth which is smaller than the thickness of the plastic film applied in step e1) are used as an embossing means in step e3). In particular, it may be provided that the embossing means has an embossing depth between 25% and 65% of the layer thickness of the plastic film.

Preferably, the embossing takes place under the action of heat. To this end, it may be provided that the plastic film is heated at least at the surface by means of suitable devices, such as IR emitters. It can also be provided that the embossing means is heated by means of suitable means. Finally, moreover a combination of these options can be provided, in which both the plastic film is preheated by means of e.g. IR emitters and then a structure is embossed into the plastic film by use of appropriately heated embossing means.

Preferably, the heat action is controlled so that the plastic film is heated to a temperature in the range between 30% and 80%, preferably between 40% and 70% of the melting temperature of the plastic film material. It has been shown that with such a heating rate, a good embossing result can be achieved without substantially adversely affecting the durability of the film.

Thus, it can be provided, for example, that when using a PET film, the heat action is controlled so that a surface temperature of the film of 130° C. is not exceeded.

According to one embodiment of the disclosure, it may be provided that prior to the embossing of the applied plastic film an embossing varnish is applied thereon, which has sufficient flexibility to be co-embossed in a subsequent embossing step. Such an embossing varnish is preferably likewise a radiation-curable varnish composition.

In one embodiment of the disclosure it is provided that the structuring of the plastic film is carried out in congruence with the decorative image in order to haptically support the realistic appearance of the decoration. To this end, it may be provided that the decorative image comprises so-called register marks, by means of which the embossing means or the already structured plastic film are aligned with respect to the decoration in order to ensure a structuring which is synchronous with the decoration.

According to a further embodiment of the disclosure it can be provided that the side of the plastic film facing the carrier is subjected to a corona treatment and/or plasma treatment prior to application onto the not yet or not yet completely cured layer of the radiation-curable varnish applied in step d). As a result, an improvement in the adhesion of the film to the radiation-curable varnish layer can be achieved.

Alternatively or in addition to the corona and/or plasma treatment described above, an adhesive primer can be applied onto the side of the plastic film facing the carrier plate.

According to one embodiment of the disclosure it may be provided to this end, that as an adhesive primer a composition is applied which comprises a swelling agent and/or a solvent suitable for the plastic film material. Such a composition may, for example, comprise acetone, methyl ethyl ketone, ethyl acetate, isobutyl acetate, tetrahydrofuran, dimethyl sulfoxide, sulfolane, acetonitrile, nitromethane, y-butyrolactone or mixtures thereof.

According to a preferred embodiment, such a composition may, for example, comprise between ≥5 wt.-% and ≤35 wt.-% isobutyl acetate and between ≥2 wt.-% and ≤65 wt.-% methyl ethyl ketone.

According to the disclosure it may be provided that the method according to method steps e2) or e2′) or e3) and thus prior to the application of the covering layer in step (f) is interrupted. In this case, a storable intermediate product or semifinished product is obtained, which can be further processed temporally and/or spatially separated from the previous production process by application of the covering layer, optionally with prior structuring. The disclosure thus expressly also encompasses a method for producing such an intermediate product, which then consists of a carrier, a primer layer, a decorative layer, a layer of a radiation-curable varnish or a hot melt disposed on the decorative layer and a plastic film.

It can also be provided that a structuring of the plastic film is mostly dispensed with and only one or more topcoat layers are applied onto the plastic film. The surface of the resulting decorative panel would thus be substantially smooth and unstructured.

Onto the layer composite obtained according to method step e2′) or e3) according to the disclosure a topcoat layer of a radiation-curable varnish is applied.

According to a further embodiment of the disclosure, it may be provided that the topcoat layer is formed by multiple application of varnish compositions of the same or of different compositions and accordingly method step f) is carried out repeatedly. Here, it can also be provided that at least one varnish layer or one varnish coating has a varnish composition which comprises hard materials such as titanium nitride, titanium carbide, silicon nitride, silicon carbide, boron carbide, tungsten carbide, tantalum carbide, alumina (corundum), zirconium oxide or mixtures thereof in order to increase the wear resistance of the layer formed. Likewise, it can be provided that at least one varnish layer or a varnish coating has a varnish composition which comprises a solid, for example, glass beads, glass ellipses or cellulose fibers in order to increase the wear resistance of the layer formed. Here, it can also be provided that a varnish layer or a varnish coating has a varnish composition which comprises both hard materials and a solid of the aforementioned type.

Finally, in step g), the topcoat layer applied in step f) is cured. In a repetition of step f) in the manner previously described it may be provided that step g) is also repeated, optionally with the proviso that between the repetition of step f) no complete curing of the applied varnish composition takes place, but only a partial curing or gelling, and a final curing is carried out by a correspondingly long and/or intensive action of suitable electromagnetic radiation, such as UV radiation or microwave radiation.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

The disclosure is explained below with reference to the figures and an exemplary embodiment.

FIG. 1 shows schematically the structure of a decorated and surface-structured wall or floor panel according to the disclosure;

FIG. 2 shows schematically an intermediate product which can be obtained in the context of the method according to the disclosure;

FIG. 3 shows schematically a further intermediate product which can be obtained in the context of the method according to the disclosure; and

FIG. 4 shows schematically a decorated wall or floor panel with an unstructured plastic film.

Corresponding reference numerals indicate corresponding parts throughout the several views of the drawings.

### DETAILED DESCRIPTION

Example embodiments will now be described more fully with reference to the accompanying drawings.

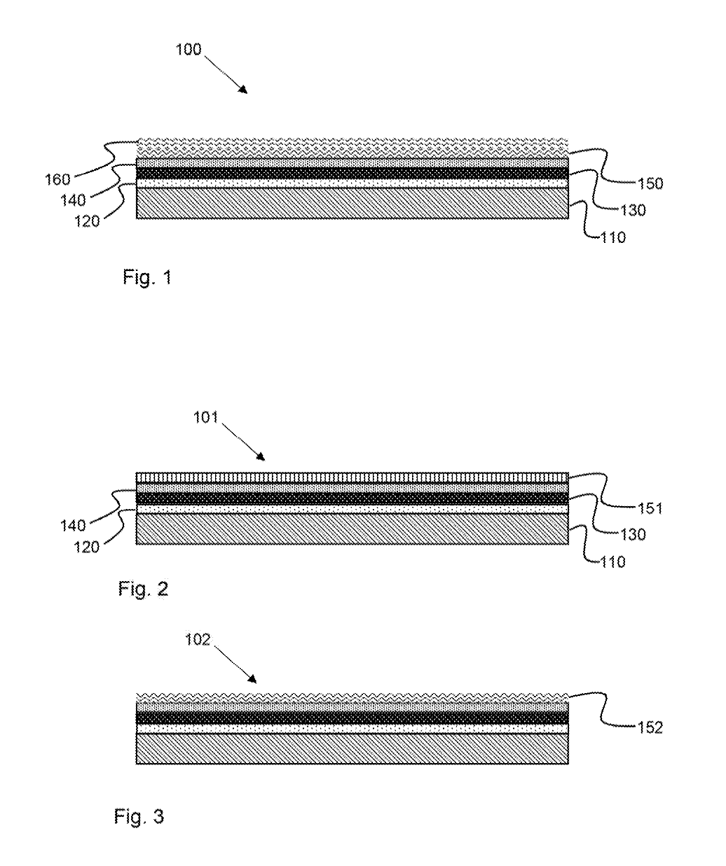

FIG. 1 schematically shows the structure of a decorated and surface-structured wall and/or floor panel 100 according to the disclosure. The panel comprises a carrier 110 preferably made of a fiber cement material. On a surface of the carrier 110 a primer layer 120 is disposed which also can serve as a printing subsurface for the decorative layer 130 disposed thereon. The decorative layer 130 can be applied onto the primer layer 120 by means of a direct printing process such as flexographic printing, offset printing or screen printing processes, and in particular by means of digital printing techniques, such as inkjet processes or laser printing processes. On the decorative layer 130, in turn, a layer 140 of a radiation-curable varnish or a hot melt is disposed, by means of which the structured plastic film 150 disposed on the layer 140 is bonded to the layer composite. Above the structured plastic film 150, a topcoat layer 160 is disposed. It may be provided that the topcoat layer 160 comprises hard materials and/or solids and/or fibers for improving the wear resistance. In any case, the topcoat layer is designed such that it does not or not completely level out the surface structure caused by the structured plastic film, so that it is at least partially haptically perceptible at the surface of the wall or floor panel.

FIG. 2 shows schematically an intermediate product 101, as can be obtained in the context of the method according to the disclosure. Here, the layers 110, 120, 130 and 140 correspond to the layers known from FIG. 1. Instead of an already pre-structured plastic film the intermediate product shown in FIG. 2 comprises a not or not completely structured plastic film 151. In an optional temporally and/or spatially separated further processing step, the surface of the intermediate product 101 formed by the plastic film can be structured by means of suitable embossing means, in particular under the action of heat. In a further optional temporally and/or spatially separated further processing step then a topcoat layer can be applied.

FIG. 3 shows schematically an intermediate product 102, as can be obtained in the context of the method according to the disclosure. Here, the layers 110, 120, 130 and 140 correspond to the layers known from FIG. 1. The layer 152 represents a structured plastic film in the embodiment shown. It may either be an already pre-structured plastic film or a non-structured plastic film as shown in FIG. 2, which in an optional temporally and/or spatially separated further processing step has been structured by means of suitable embossing means, in particular under the action of heat. In a further optional temporally and/or spatially separated further processing step then a topcoat layer can be applied.

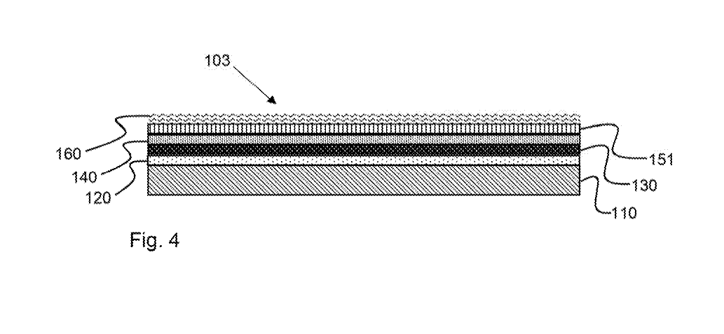

FIG. 4 shows schematically a decorated wall or floor panel 103, as can be obtained in the context of the method according to the disclosure. The layers 110, 120, 130 and 140 correspond to the layers known from FIG. 1. In an optional temporally and/or spatially separate further processing step then a topcoat layer 160 can be applied.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are to be regarded as a departure from the disclosure, and all such modifications are intended to be included within the scope of the disclosure.

1. A decorated wall or floor panel comprising:
a carrier made of a fiber cement material;
a primer layer disposed on a surface of the carrier;
a decorative layer disposed on the primer layer;
a layer of a radiation-curable varnish or a hot melt disposed on the decorative layer;
a structured plastic film disposed on the layer of a radiation-curable varnish or hot melt; and
a topcoat layer disposed on the structured plastic film.

2. the decorated wall or floor panel according to claim 1, wherein the carrier comprises a fiber cement material which includes inorganic, organic, metallic, synthetic fibers or mixtures thereof.

3. The decorated wall or floor panel according to claim 1, wherein the primer layer comprises a radiation-curing urethane and/or urethane acrylate.

4. The decorated wall or floor panel according to claim 1, wherein the decorative layer comprises at least one radiation-curing ink composition.

5. The decorated wall or floor panel according to claim 1, wherein the varnish applied onto the decorative layer in order to form a layer of a radiation-curable varnish comprises an acrylate, a diacrylate, a methacrylate, a urethane, urethane acrylate or mixtures thereof.

6. The decorated wall or floor panel according to claim 1, wherein the structured plastic film is made of a plastic selected from the group consisting of polypropylene (PP), polyethylene (PE), polyethylene terephthalate (PET), polycarbonate (PC), polybutylene terephthalate (PBT), a polytrimethylene terephthalate (PTT), a copolymer or a block copolymer thereof.

7. The decorated wall or floor panel according to claim 1, wherein the structured plastic film has a thickness between >60 μm and ≤500 μm, preferably between ≥80 μm and ≤350 μm, in particular between ≥100 μm and ≤300 μm.

8. The decorated wall or floor panel according to claim 1, wherein the structured plastic film has an embossing depth between 60 μm and 180 μm.

9. The decorated wall or floor panel according to claim 1, wherein the varnish applied onto the structured plastic film for forming a topcoat layer comprises an acrylate, a diacrylate, a methacrylate, a urethane, urethane acrylate or mixtures thereof.

10. the decorated wall or floor panel according to claim 1, wherein the panel comprises complementary locking means at at least two opposite edges by means of which panels can be joined together in order to form a connected wall or floor covering.

11. A method for producing a decorated wall or floor panel, comprising the steps:
a) providing a carrier made of a fiber cement material;
b) applying a primer layer onto a surface of the provided carrier;
c) applying a decorative layer onto the primer layer applied in step b) by means of a direct printing process;
d) applying a layer of a radiation-curable varnish or a hot melt onto the decorative layer applied in step c); then either
e1) applying a non-structured plastic film onto the not yet or not yet completely cured layer of the radiation-curable varnish or hot melt applied in step d);
e2) curing the layer of a radiation-curable varnish or hot melt applied in step d) by the action of suitable electromagnetic radiation or cooling, wherein the plastic film applied in step e1) is bonded to the remaining layer structure;
e3) structuring the non-structured plastic film applied in step e1) by an embossing means to form a structured plastic film; or
e1′) applying a structured plastic film onto the not yet or not yet fully cured layer of the radiation-curable varnish or hot melt applied in step d);
e2′) curing the layer of the radiation-curable varnish or hot melt applied in step d) by the action of suitable electromagnetic radiation or cooling, wherein the plastic film applied in step e1′) is bonded to the remaining layer structure;
subsequently
f) applying at least one covering layer of a radiation-curable varnish onto the structured plastic film; and
g) curing the at least one covering layer applied in step f).

12. The method according to claim 11, wherein as the embossing means in step e3) an embossing roller, an embossing plate or an embossing die with an embossing depth is used, which is less than the thickness of the plastic film applied in step e1).

13. The method according to claim 11, wherein step e3) is carried out under the action of heat and the heat action is controlled such that the plastic film is heated to a temperature in the range between 30% and 80%, preferably 40% and 70% of the melting temperature of the plastic film material.

14. The method according to claim 11, wherein the side of the plastic film facing the carrier is subjected to a corona treatment and/or a plasma treatment prior to the application onto the not yet or not yet fully cured layer of the radiation-curable varnish or hot melt applied in step d) and/or an adhesive primer is applied onto the side of the plastic film facing the carrier plate.

15. The method according to claim 14, wherein a composition comprising a swelling agent and/or a solvent suitable for the plastic film material is applied as an adhesive primer.
